(19) United States
(12) Patent Application Publication
(10) Pub. No.: US 2005/0185000 A1
(43) Pub. Date: Aug. 25, 2005

(54) Representative color selection apparatus and method, reduced color image production apparatus and method, and programs

(75) Inventor: Shunichiro Nonaka, Asaka-shi (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co, Ltd., Minamiashigara-shi (JP)

(21) Appl. No.: 11/060,785

(22) Filed: Feb. 18, 2005

(30) Foreign Application Priority Data
Feb. 19, 2004 (JP) 043127/2004

(51) Int. Cl. G09G 5/02

(52) U.S. Cl. 345/590; 345/591

(57) ABSTRACT

Color distribution of the colors of pixels of an image is generated in an RGB color space. The color space is modified so that the length of each of an R-axis, G-axis, and B-axis in the RGB color space satisfies the ratio of 3:4:2. Color distribution is generated in the modified color space. The modified color space is divided, based on the color distribution, into a predetermined number of regions, which is less than the number of colors of the image, by using median cut algorithm. A color, which is a median in each of the divided regions, is selected as a representative color.

### BACKGROUND OF THE INVENTION

1. Field of the Invention

The present invention relates to a representative color selection apparatus and method for selecting a predetermined number of representative colors from the colors of pixels in an image to produce a reduced color image having the predetermined number of colors, which is less than the number of colors of the image. The present invention also relates to a reduced color image production apparatus and method for producing a reduced color image from an image. The present invention also relates to an image delivery apparatus for delivering images to mobile terminal devices, or the like. The present invention also relates to an e-mail relay apparatus for relaying e-mails, to which images are attached, to transmission destinations. The present invention also relates to a program for causing a computer to execute the representative color selection method. The present invention also relates to a program for causing a computer to execute the reduced color image production method.

2. Description of the Related Art

Images obtained with digital cameras, scanners or the like can be represented by colors in 8 bits for each of RGB colors, which are 24-bit colors in total. Specifically, the images can be represented by approximately 16.77 million colors. However, some image reproduction devices can reproduce a smaller number of colors (for example, 256 colors). Further, only 256 colors can be processed in image formats such as gif (Graphic Interchange Format) and png (Portable Network Graphic), which are frequently used in websites. Therefore, when the images, which were obtained with the digital cameras or the like, are displayed at the reproduction devices, which can reproduce a smaller number of colors, or when the format of data is converted into image formats such as gif and png, color reduction processing is required to reduce the number of colors from 16.77 million to 256.

Conventionally, the color reduction processing as described above is performed by selecting 256 representative colors from the colors of pixels in an original image. The representative colors are optimal colors for representing the image, on which color reduction processing will be performed, in 256 colors. Then, distances between the color of each pixel in the original image and all of the representative colors are calculated in a color space of the original image. A reduced color image is produced by assigning a representative color, to which the distance from the color of each pixel is the shortest, to a corresponding pixel in the reduced color image (Japanese Unexamined Patent Publication No. 4(1992)-190466).

Here, as an algorithm for selecting the representative colors, the median cut algorithm is well known (Refer to “Color Image Quantization for Frame Buffer Display”, Paul Heckbert, ACM, Computer Graphics, pp. 297-304, 1982). In the median cut algorithm, the representative colors are selected as described below. First, the color of each pixel in an image is plotted in a color space (for example, an RGB color space) of the image to obtain color distributions of each pixel in the color space. A region of the color space, in which the colors of pixels exist, is divided into a predetermined number of regions by dividing the region perpendicularly with respect to an axis of each base color of RGB. Specifically, a longest side (referred to as “longest side” hereinafter) is obtained in each of existing regions at the time of division. Further, regarding a region (largest region), of which the longest side is the longest among all of the regions, a boundary, which is perpendicular to the longest side, and which passes through the representative color (a color having a median, average, centroid value, or the like, for example) of the largest region, is set. The largest region is divided by the boundary. When there is a plurality of regions, in which the lengths of the longest sides are the same, a region, of which the second longest side is the longest among the plurality of regions, is selected. Then, a boundary, which is perpendicular to the longest side, and which passes through the representative color of the largest region, is set in the selected largest region, and the largest region is divided by the boundary. Then, a color having a median, average, centroid value, or the like in each of the predetermined number of regions, which are obtained as described above, is selected as a representative color.

FIGS. 22A through 22D are diagrams for explaining the median cut algorithm. Here, for the purpose of explanation, it is assumed that an image includes two color components of R and G. First, as illustrated in FIG. 22A, color distribution of each pixel in the image is generated by plotting the color of each pixel in RG color space. A median in the color space is obtained in this state, and a region is divided at the position of the median. At an initial stage, the color space is not divided into regions. Therefore, it is assumed the color space is divided into regions by dividing the region perpendicularly with respect to aG-axis. FIG. 22B illustrates a divided state. Accordingly, two regions A1 and A2 are formed.

Here, the longest sides of the regions A1 and A2 are the same. However, the second longest side of the region A1 is longer than that of A2. Therefore, a boundary, which passes through a median in the region A1, and which is perpendicular to the longest side, is set. The longest side is parallel to an R-axis. Accordingly, the region A1 is divided into regions A11 and A12, as illustrated in FIG. 22C.

Next, among the regions A2, A11, and A12, the longest side of the region A2 is the longest. Therefore, a boundary, which passes through a median in the region A2, and which is perpendicular to the R-axis, which is the longest side, is set. Accordingly, the region A2 is divided into regions A21 and A22, as illustrated in FIG. 22D.

Regions are divided repeatedly until a predetermined number of regions are formed. Then, a color, which is a median in each of the predetermined number of regions, is selected as a representative color. When regions are formed as illustrated in FIG. 22D by dividing, a color, which is a median in each of the regions A11, A12, A21, and A22, is a representative color. When color reduction processing is performed, distances between all of the representative colors and the color of each pixel are calculated, and a representative color, from which the distance to the color of the pixel is the shortest, is assigned to a corresponding pixel in a reduced color image.

Meanwhile, the function of mobile terminal devices such as cellular phones with cameras is rapidly improving. Communication speeds are also increasing. Under these circumstances, a mobile terminal device is proposed, which has a function of taking a photograph of an image and sending the obtained image by attaching it to an e-mail, or a function of accessing an image delivery server, which delivers image content, and downloading desired image content to reproduce it.

An e-mail relay apparatus for performing appropriate image processing, based on the types of terminal devices at transmission destinations, on e-mails, which are sent from mobile terminal devices with cameras, and to which images are attached, is proposed (U.S. Patent Application Publication No. 20040105119). If the e-mail relay apparatus as described above is used, e-mails, to which images are attached, may be sent to the terminal devices at the transmission destinations by performing image processing on image data so as to produce images, which are appropriate for a display size, and brightness, hue, or the like of the terminal devices at the transmission destinations.

Human visual sense characteristics are different depending on colors. The sensitivity for G is the highest, and the sensitivity is lower in the order of R and B after G. However, in the method for selecting representative colors in an RGB color space by using the median cut algorithm, as described above, the human visual sense characteristics are not considered. Therefore, there is a problem that appropriate colors for the human visual sense characteristics are not always selected as the representative colors. Further, when a representative color is assigned to the color of each pixel in an image, as disclosed in Japanese Unexamined Patent Publication No. 4(1992)-190466, the human visual sense characteristics are not considered. Therefore, there is a problem that colors are not assigned to the colors of the pixels in an appropriate manner for the human visual sense characteristics. To solve the problem, the color of each pixel in an image may be transformed to a color in a color space such as a Lab color space, which is appropriate for the human visual sense characteristics, instead of the RGB color space. Then, representative colors may be selected in the Lab color space, and the selected representative colors may be assigned to the colors of pixels.

However, since transformation from the RGB color space to the Lab color space includes nonlinear transformation, the operation amount of the transformation is large, and a long time is required for processing. Further, the number of displayable colors at display devices is limited in the RGB color space. Therefore, there is a problem that colors, selected in the Lab color space, are not always appropriate colors for the limitation of the displayable colors at the display devices.

### SUMMARY OF THE INVENTION

In view of the foregoing circumstances, it is a first object of the present invention to select a representative color, which is appropriate for human visual sense characteristics, as the color of each pixel in an image.

It is a second object of the present invention to assign an appropriate representative color to the color of each pixel in the image for human visual sense characteristics.

A representative color selection apparatus according to the present invention is a representative color selection apparatus for selecting a predetermined number of representative colors from colors of pixels in an image to produce a reduced color image, represented by the predetermined number of colors, which is less than the number of reproducible colors of the image, the apparatus comprising:
a color distribution generation means for generating color distributions of the color of each of the pixels in modified color space, in which the length of an axis of each base color in a color space of the image is modified to a length, which is appropriate for human visual sense characteristics, and which are different from each other;
a region division means for dividing the modified color space, based on the color distribution, into a predetermined number of regions, which is the same as the number of the predetermined number of colors, by using median cut algorithm; and
a selection means for selecting a representative color of each of the divided regions.

The “representative color” may be any color as far as the color represents each of the divided regions. A color represented by one of a median, average, and centroid value may be used as the representative color.

The term “axis of base color” refers to an axis of base color in the color space of an image. For example, if the color space of the image is RGB color space, each of an R-axis, G-axis, and B-axis, which pass through the origin of the color space, is the axis of base color.

Here, if the maximum value of each of the base colors is the same in the color space of the image, when color distributions of the color of each pixel in the image are generated in the color space, the length from the origin to the maximum value of the base color on an axis of each base color is the same for all of the base colors. For example, if the color space is RGB color space and the maximum value of each of the base colors is 256, color distributions are generated within the range of 0 through 255 in an axis of each of base colors of RGB. In this case, the length representing each value of 0 through 255 on an axis of each base color is the same for all of the base colors.

The phrase “the length of an axis of each base color is modified to a length, which is appropriate for human visual sense characteristics, and which are different from each other” refers to increasing or decreasing the length of an axis of each base color so that the length becomes appropriate for the human visual sense characteristics. The length from the origin to the maximum value on an axis of each base color is not set to the same length.

In the representative color selection apparatus according to the present invention, when the color space is an RGB color space, the color distribution generation means may be a means for modifying the length of an axis of each base color so as to satisfy G>R>B.

Specifically, it is preferable that the length of an axis of each base color of RGB satisfies the ratio of approximately 3:4:2.

A reduced color image production apparatus according to the present invention is a reduced color image production apparatus for producing a reduced color image including a predetermined number of representative colors, selected from the colors of pixels in an image, by assigning one of the predetermined number of representative colors to each of the pixels, the apparatus comprising:
an image production means for producing the reduced color image in modified color space, in which the length of an axis of each base color in a color space of the image is modified to a length, which is appropriate for human visual sense characteristics, and which are different from each other, by calculating distances between the color of each of the pixels and all of the representative colors and assigning a representative color, from which the distance to the color of each of the pixels is the shortest, to a corresponding pixel in the reduced color image.

In the reduced color image production apparatus according to the present invention, when the color space is RGB color space, the color distribution generation means may be a means for modifying the length of an axis of each base color so as to satisfy G>R>B.

Specifically, it is preferable that the length of an axis of each base color satisfies the ratio of approximately R:G:B=√2:√3:1.

Further, in the reduced color image production apparatus according to the present invention, the representative color may be selected by a representative color selection apparatus according to the present invention.

In this case, the degree of modifying the length of an axis of each base color in the color space of the original image may be different between selection time of the representative colors and assignment time of the representative colors to the pixels.

An image delivery apparatus according to the present invention is an image delivery apparatus for sending a requested image to a transmission request terminal device, which has requested transmission of the image, the apparatus comprising:
a model type discrimination means for discriminating the model type of the transmission request terminal device; and
a reduced color image production apparatus according to the present invention, wherein when the number of displayable colors of the model type of the transmission request terminal device is less than the number of colors of the image, a reduced color image is produced from the requested image, and the reduced color image is sent to the transmission request terminal device instead of the image.

An e-mail relay apparatus according to the present invention is an e-mail relay apparatus for sending an e-mail, to which an image is attached, to a transmission destination terminal device, which is a transmission destination of the e-mail, the apparatus comprising:
a model type discrimination means for discriminating the model type of the transmission destination terminal device; and
a reduced color image production apparatus according to the present invention, wherein when the number of displayable colors of the model type of the transmission destination terminal device is less than the number of colors of the image, a reduced color image is produced from the attached image, and the reduced color image is sent to the transmission destination terminal device instead of the image.

A representative color selection method according to the present invention is a representative color selection method for selecting a predetermined number of representative colors from the colors of pixels in an image to produce a reduced color image, represented by the predetermined number of colors, which is less than the number of reproducible colors of the image, the method comprising the steps of:
generating color distribution of the color of each of the pixels in modified color space, in which the length of an axis of each base color in a color space of the image is modified to a length, which is appropriate for human visual sense characteristics, and which are different from each other;
dividing the modified color space, based on the color distribution, into a predetermined number of regions, which is the same as the number of the predetermined number of colors, by using median cut algorithm; and
selecting a representative color of each of the divided regions.

A reduced color image production method according to the present invention is a reduced color image production method for producing a reduced color image including a predetermined number of representative colors, selected from the colors of pixels in an image, by assigning one of the predetermined number of representative colors to each of the pixels, the method comprising the step of:
producing the reduced color image in modified color space, in which the length of an axis of each base color in a color space of the image is modified to a length, which is appropriate for human visual sense characteristics, and which are different from each other, by calculating distances between the color of each of the pixels and all of the representative colors and assigning a representative color, from which the distance to the color of each of the pixels is the shortest, to a corresponding pixel in the reduced color image.

Further, the representative color selection method and the reduced color image production method according to the present invention may be provided as programs for causing a computer to execute the methods.

According to the representative color selection apparatus and method of the present invention, color distribution of the color of each pixel is generated in modified color space, in which the length of an axis of each base color in the color space of the image is modified to a length, which is appropriate for the human visual sense characteristics, and which are different from each other. Then, the modified color space is divided into a predetermined number of regions, based on the generated color distribution, by using the median cut algorithm. Then, a representative color of each of the divided regions is selected.

Here, when the color space is an RGB color space, if the length of an axis of each base color satisfies G>R>B, the direction of an axis, which will be divided by using the median cut algorithm, tends to be selected in the order of G, R, and B. Accordingly, the number of divided regions is larger in the order of G, R, and B. Therefore, color components of each representative color are divided into smaller regions in the order of G, R, and B.

In the human visual sense characteristics, the sensitivity for G is the highest, and the sensitivity is lower in the order of R and B after G. Therefore, when the difference in values is small, the difference in color of G is recognized better than that of B. Therefore, when a reduced color image is produced, if the number of times of division is increased regarding a color, for which the sensitivity is higher in the human visual sense characteristics, a reduced color image, which looks more natural, can be produced. Therefore, in the representative color selection apparatus and method according to the present invention, representative colors may be selected so that the reduced color image, which is appropriate for the human visual sense characteristics, is produced.

According to the reduced color image production apparatus and method of the present invention, a reduced color image is produced in a modified color space, by calculating distances between the color of each pixel and all of representative colors and assigning a representative color, from which the distance to the color of each pixel is the shortest, to a corresponding pixel in the reduced color image. The modified color space is space, in which the length of an axis of each base color in the color space of the image is modified to a length, which is appropriate for the human visual sense characteristics.

Here, in the human visual sense characteristics, the sensitivity for G is the highest, and the sensitivity is lower in the order of R and B after G. Therefore, when the difference in the value of colors is small, the difference in colors of G is recognized better than that of B. In the reduced color image production apparatus and method according to the present invention, when the color space is RGB color space, the length of an axis of each base color satisfies G>R>B. Therefore, the characteristics of the color space are appropriate for the human visual sense characteristics. Accordingly, a reduced color image, which looks natural, may be produced in a modified color space by calculating the distances between the color of each pixel and all of the representative colors and assigning a representative color, from which the distance to the color of each pixel is the shortest, to a corresponding pixel in the reduced color image.

According to the image delivery apparatus of the present invention, the model type of a transmission request terminal device, which has requested transmission of the image, is discriminated. If the number of displayable colors of the model type of the transmission request terminal device is less than the number of colors in the image, a reduced color image is produced from the image in a similar manner to production of the reduced color image at the reduced color image production apparatus according to the present invention. The reduced color image is sent to the transmission request terminal device instead of the image. Therefore, even if the number of displayable colors at the terminal device, which has requested transmission of the image, is less than the number of colors in the image, a pseudo image may be displayed by using the reduced color image.

According to the e-mail relay apparatus of the present invention, the model type of the transmission destination terminal device, which is the transmission destination of the e-mail, to which an image is attached, is discriminated. If the number of displayable colors of the model type of the transmission destination terminal device is less than the number of colors of the image, a reduced color image is produced from the image in a similar manner to production of the reduced color image at the reduced color image production apparatus according to the present invention. The reduced color image is sent to the transmission destination terminal device instead of the image. Therefore, even if the number of displayable colors at the transmission destination terminal device is less than the number of colors of the image, a pseudo image of the image, which was sent by being attached to the e-mail, may displayed at the terminal device by using the reduced color image.

Note that the program of the present invention may be provided being recorded on a computer readable medium. Those who are skilled in the art would know that computer readable media are not limited to any specific type of device, and include, but are not limited to: floppy disks, CD's RAM'S, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic block diagram illustrating the configuration of an image delivery system, to which a reduced color image production apparatus and an image delivery apparatus according to a first embodiment of the present invention are applied;

FIG. 2 is a table illustrating the relationship between model types and formats;

FIG. 3 is a schematic block diagram illustrating the configuration of a color reduction processing unit in detail;

FIG. 4 is a diagram illustrating color space, in which each color of RGB is represented by values of 0 through 255;

FIG. 5 is a diagram illustrating color space, in which the length of an axis of each color of RGB is modified so as to satisfy the ratio of 3:4:2;

FIG. 6A is a diagram for explaining median cut algorithm in the present invention;

FIG. 6B is a diagram for explaining median cut algorithm in the present invention;

FIG. 6C is a diagram for explaining median cut algorithm in the present invention;

FIG. 6D is a diagram for explaining median cut algorithm in the present invention;

FIG. 7 is a diagram illustrating color space, based on human visual sense characteristics, which is divided by median cut algorithm according to the related art;

FIG. 8 is a diagram illustrating color space, in which the length of an axis of each color of RGB is modified so as to satisfy the ratio of √2:√3:1;

FIG. 9 is a diagram for explaining assignment of colors in the present invention;

FIG. 10 is a diagram, based on the human visual sense characteristics, for explaining assignment of colors according to the related art;

FIG. 11 is a flow chart illustrating processing performed in the first embodiment of the present invention;

FIG. 12 is a flow chart illustrating color reduction processing;

FIG. 13 is a schematic block diagram illustrating the configuration of an e-mail system, to which an e-mail relay apparatus according to a second embodiment of the present invention is applied;

FIG. 14 is a flow chart (No. 1) illustrating processing performed in the second embodiment;

FIG. 15 is a flow chart (No. 2) illustrating processing performed in the second embodiment;

FIG. 16 is a flow chart (No. 3) illustrating processing performed in the second embodiment;

FIG. 17 is a flow chart (No. 4) illustrating processing performed in the second embodiment;

FIG. 18 is a flow chart (No. 5) illustrating processing performed in the second embodiment;

FIG. 19 is a flow chart illustrating processing performed at an e-mail relay server when a request is sent;

FIG. 20 is a schematic block diagram illustrating the configuration of an e-mail system, to which an e-mail relay apparatus according to a third embodiment of the present invention is applied;

FIG. 21 is a schematic block diagram illustrating the configuration of an e-mail system, to which an e-mail relay apparatus according to a fourth embodiment of the present invention is applied; and

FIGS. 22A through 22D are diagrams for explaining median cut algorithm according to the related art.

### DESCRIPTION OF THE PREFERRED EMBODIMENTS

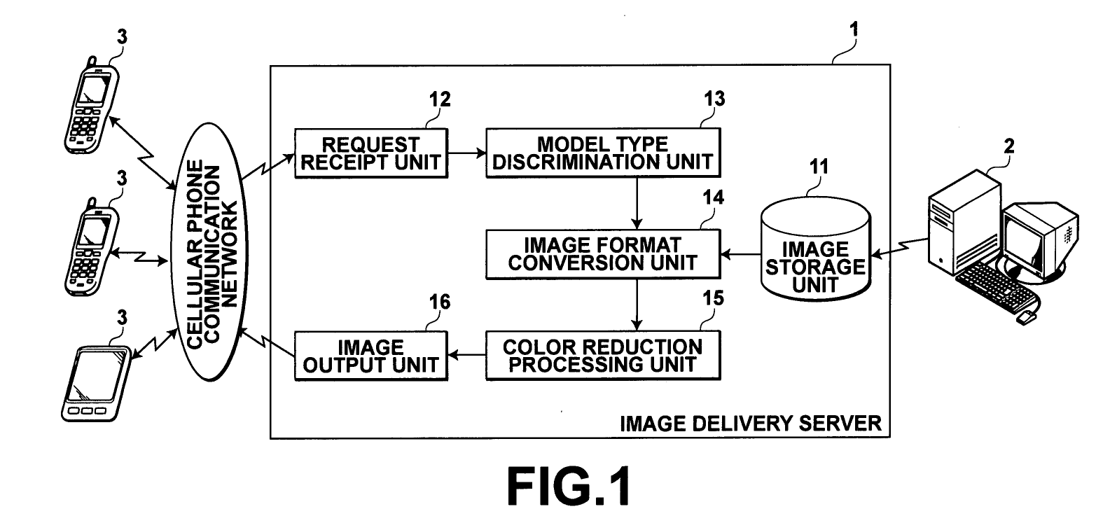

Hereinafter, embodiments of the present invention will be described with reference to the attached drawings. FIG. 1 is a schematic diagram illustrating an image delivery system, to which a reduced color image production apparatus and an image delivery apparatus according to a first embodiment of the present invention are applied. As illustrated in FIG. 1, the image delivery system according to the first embodiment of the present invention includes an image delivery server 1. Image data S0, which is generated at a personal computer 2, or the like, which is an image content generation apparatus, is stored in the image delivery server 1. A mobile terminal device 3 such as a cellular phone, PHS (personal handyphone system), and PDA (personal digital assistance) sends an image delivery request to the image delivery server 1 via a cellular phone communication network. Then, the image delivery server 1 sends the image data S0 to the mobile terminal device 3.

As illustrated in FIG. 1, the image delivery server 1 includes an image storage unit 11, a request receipt unit 12, a model type discrimination unit 13, an image format conversion unit 14, a color reduction processing unit 15, and an image output unit 16.

The image storage unit 11 stores a plurality of sets of image data S0, generated at the personal computer 2. The image data S0 is encoded in a predetermined compression format and stored in the image storage unit 11. The image data S0 has a number of colors, represented in 8 bits, for each color of RGB.

The request receipt unit 12 receives an image delivery request, which is sent by the mobile terminal device 3. The image delivery request, which is sent by the mobile terminal device 3, includes the file name of the requested image data S0 and model type information representing the model type of the mobile terminal device 3.

The model type discrimination unit 13 discriminates the model type of the mobile terminal device 3 based on the model type information, included in the request.

The image format conversion unit 14 reads out the image data S0, which has the file name included in the request, from the image storage unit 11. Further, the image format conversion unit 14 decodes the image data S0. Then, the image format conversion unit 14 converts the format of the image data S0, which was read out, based on the model type of the mobile terminal device, which was discriminated by the model type discrimination unit 13. At this time, the image format conversion unit 14 converts the format of the image data S0 with reference to a table indicating the relationship between model types and formats.

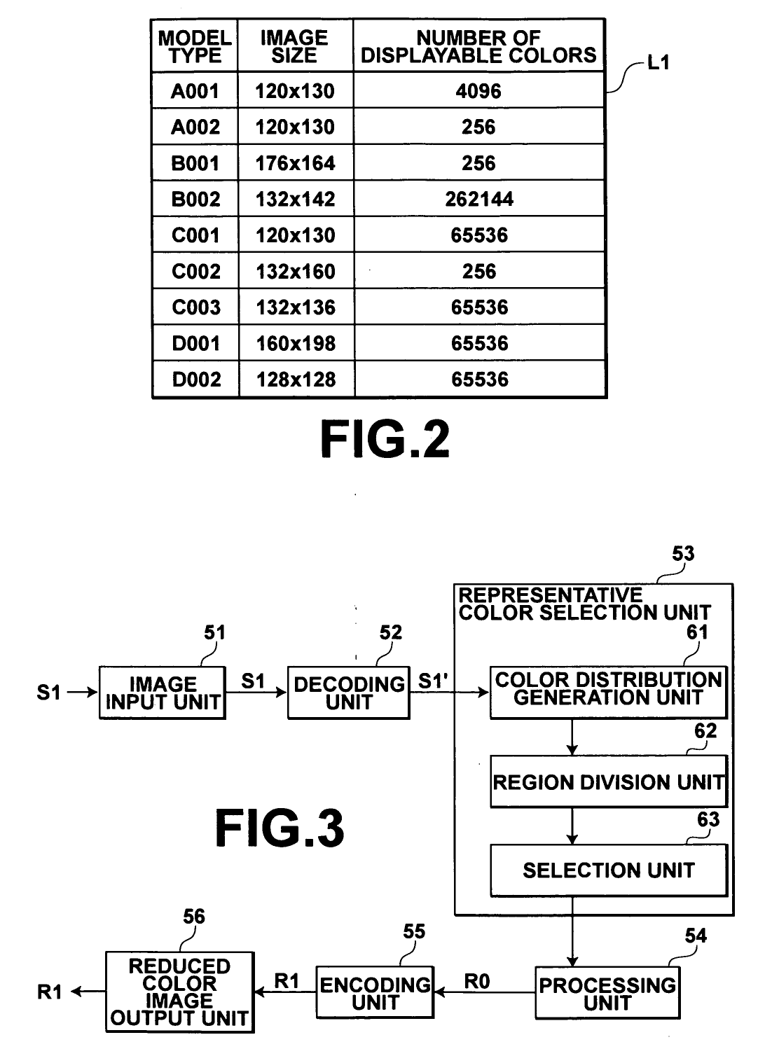

FIG. 2 is a table illustrating the relationship between model types and formats. As illustrated in FIG. 2, a display size and the number of displayable colors are assigned to each model type of the mobile terminal device 3, which is a cellular phone, in table L1. Then, the image format conversion unit 14 coverts the format of the image data S0, with reference to the table L1, so that the format of the image data S0 becomes appropriate for the size of the display screen of the model type of the mobile terminal device 3, which has requested transmission of the image data S0. Accordingly, the image format conversion unit 14 generates image data S1 after format conversion. The image data S1 is encoded.

When the number of displayable colors at the mobile terminal device 3, which has requested transmission of the image data S0, is less than the number of colors of the image data S0, the color reduction processing unit 15 generates reduced color image data R1 from the image data S1 after format conversion. FIG. 3 is a schematic block diagram illustrating the configuration of the color reduction processing unit 15. As illustrated in FIG. 3, the color reduction processing unit 15 includes an image input unit 51, a decoding unit 52, a representative color selection unit 53, a processing unit 54, an encoding unit 55, and a reduced color image output unit 56.

The image input unit 51 receives an input of the image data S1 after format conversion to the color reduction processing unit 15.

The decoding unit 52 decodes the encoded image data S1, and generates raw image data S1′.

The representative color selection unit 53 includes a color distribution generation unit 61, a region division unit 62, and a selection unit 63.

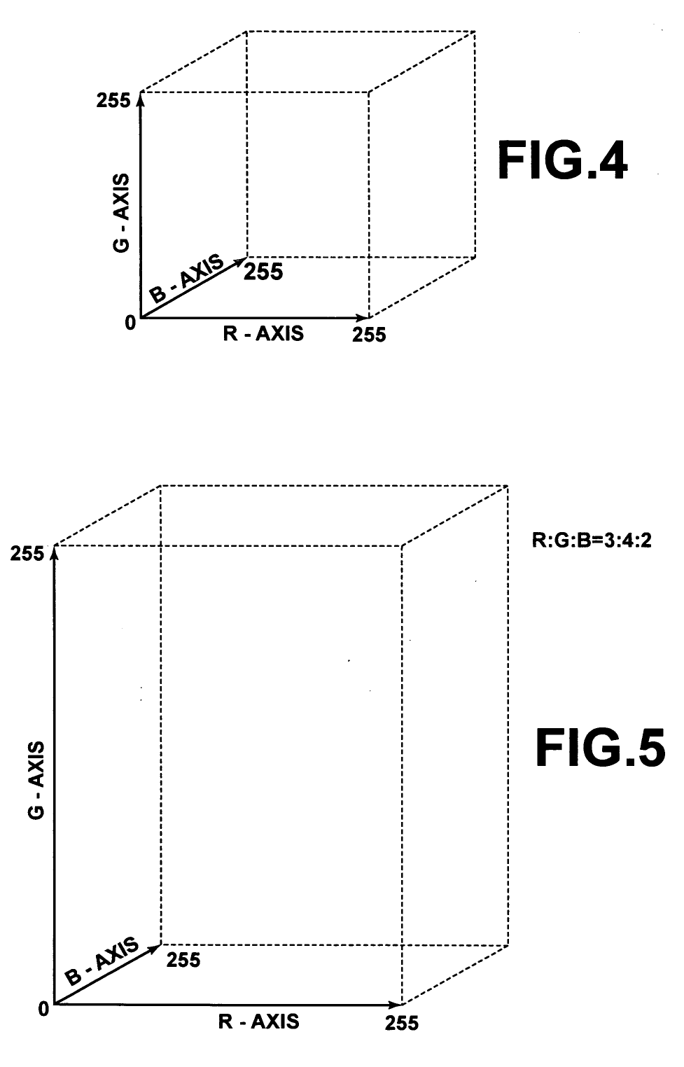

The color distribution generation unit 61 generates color distributions of the color of each pixel in an image represented by the raw image data S1′ (The same reference numeral as S1′ is used to represent the image, hereinafter.). Here, in the present embodiment, the raw image data S1′ has a number of colors, represented in 8 bits, for each color of RGB. Therefore, as illustrated in FIG. 4, the color of each pixel in an image represented by the raw image data S1′ is distributed in a color space, in which each color of RGB has values from 0 to 255. In the present embodiment, the color distribution generation unit 61 modifies the color space so that the length of an axis of each color of RGB satisfies the ratio of 3:4:2, which is appropriate for the human visual sense characteristics, as illustrated in FIG. 5. Then, the color distribution generation unit 61 generates color distribution in the color space (referred to as modified color space, hereinafter), in which the length of the axis of each color of RGB is modified.

The region division unit 62 divides, based on the color distribution in the modified color space, the modified color space into a predetermined number of regions by using median cut algorithm. Here, the predetermined number is the number of displayable colors at the mobile terminal device 3, which has requested transmission. In the present embodiment, it is assumed that the number of displayable colors at the mobile terminal device 3, which has requested transmission, is 256.

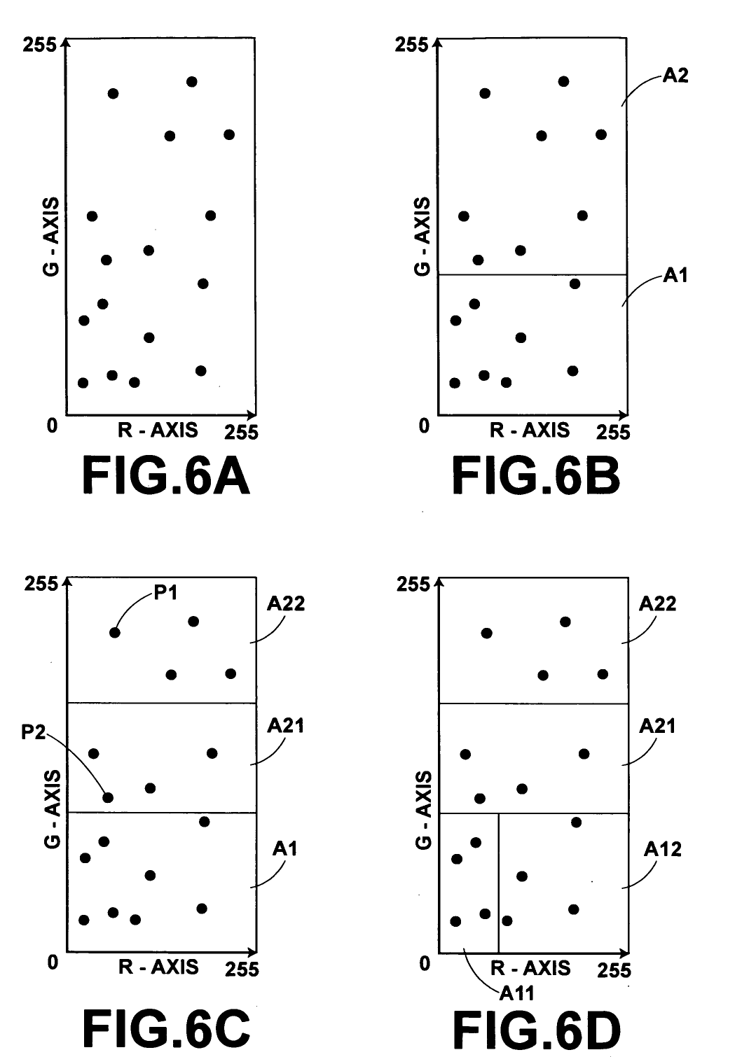

FIG. 6 is a diagram for explaining the median cut algorithm in the present embodiment. Here, for the purpose of explanation, it is assumed that an image includes two colors of R and G. First, as illustrated in FIG. 6A, color distributions of each pixel is generated by plotting the color of each pixel in an image on a modified RG color space. A median in the color space is obtained in this state, and a region is divided at the position of the median. At an initial stage, an R-axis is longer than a G-axis. Therefore, it is assumed that the color space is divided into regions by dividing the color space perpendicularly with respect to a G-axis, which is the longest side. FIG. 6B illustrates a divided state. Accordingly, two regions A1 and A2 are formed.

Here, the longest side of the region A2 is longer than the longest side of the region A1. Therefore, the region A2 is divided into regions A21 and A22, as illustrated in FIG. 6C, by setting a boundary, which passes through a median in the region A2, and which is perpendicular to the G-axis, which is the longest side of the region A2.

Next, among the longest sides of the regions A1, A21, and A22, the longest side of the region A1 is the longest. Therefore, the region A1 is divided into regions A11 and A12, as illustrated in FIG. 6D, by setting a boundary, which passes through a median in the region A1, and which is perpendicular to the R-axis, which is the longest side of the region A1.

Then, the region is divided repeatedly until the number of regions reaches 256. Accordingly, the modified color space is divided into 256 regions.

The selection unit 63 selects a color, which is a median in each of the 256 regions divided by the region division unit 62, as a representative color.

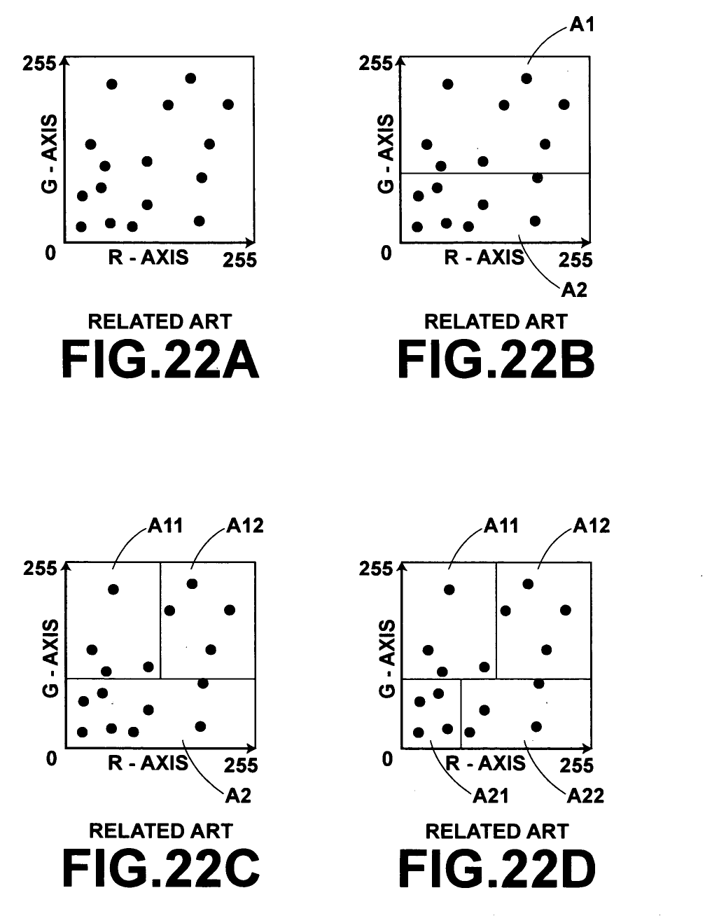

Here, if the region is divided by using the median cut algorithm without modifying the length of an axis of each color of RGB, the region is divided, as illustrated in FIGS. 22A through 22D.

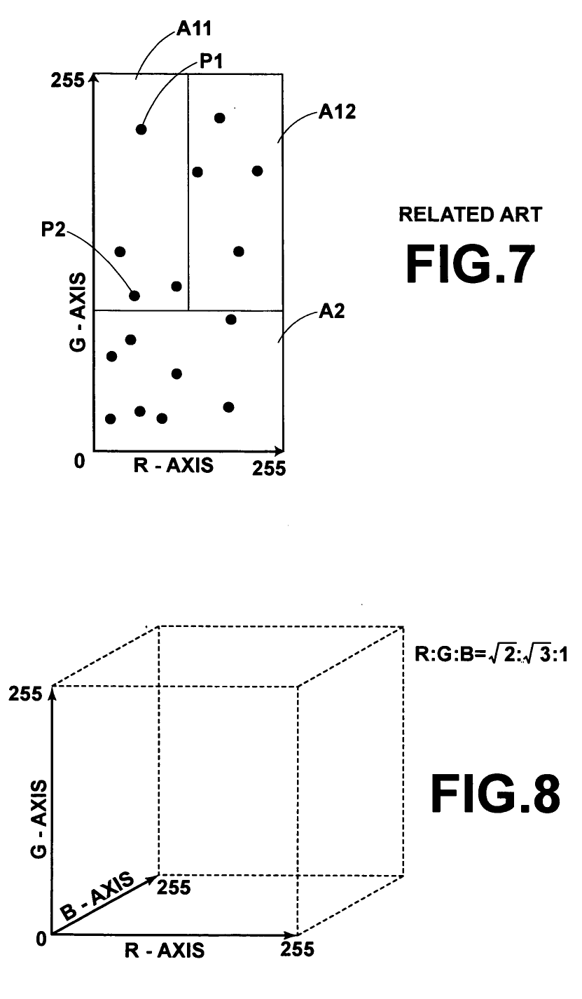

In the human visual sense characteristics, the sensitivity for G is the highest, and the sensitivity is lower in the order of R and B after G. Therefore, when the region was divided, by using the median cut algorithm, without modifying the length of an axis of each color of RGB, the region was divided as illustrated in FIG. 22C. However, if the divided regions are illustrated based on the human visual sense characteristics, they may be illustrated as FIG. 7. As illustrated in FIG. 7, if the region is divided by using median cut algorithm according to conventional techniques, when a reduced color image is produced, the same color is assigned to visually different colors (for example, colors P1 and P2 in the region A11).

According to the present embodiment, as illustrated in FIG. 6C, although the number of divided regions in FIG. 6C is the same as the number of divided regions in FIG. 22C, the colors P1 and P2 are included in different regions A22 and A21, respectively. Therefore, when a reduced color image is produced as described later, a different color is assigned to each of the colors P1 and P2.

The processing unit 54 plots 256 representative colors, selected by the representative color selection unit 53, in RGB color space. The processing unit 54 calculates the distance D between the color of each pixel in the raw image S1′ and each of all the representative colors, by using the following equation (1):
D=√((r−Rn)²+(g−Gn)²+(b−Bn)²) (1)
, where r, g, and b are the colors of pixels, and Rn, Gn, and Bn are representative colors.

The processing unit 54 assigns a representative color, from which the distance to the color of the pixel is the shortest, to a corresponding pixel in a reduced color image to generate reduced color raw image data R0 representing a reduced color image.

Here, in the present embodiment, the raw image data S1′ has a number of colors, represented in 8 bits, for each color of RGB. Therefore, the color of each pixel, represented by the raw image data S1′, is distributed in a color space, in which each color of RGB has values of 0 through 255, as illustrated in FIG. 4. However, the processing unit 54 modifies the color space so that the length of an axis of each color of RGB satisfies the ratio of √2:√3:1, as illustrated in FIG. 8. The processing unit 54 performs assignment of colors in the color space (referred to as modified color space, hereinafter), which has been modified.

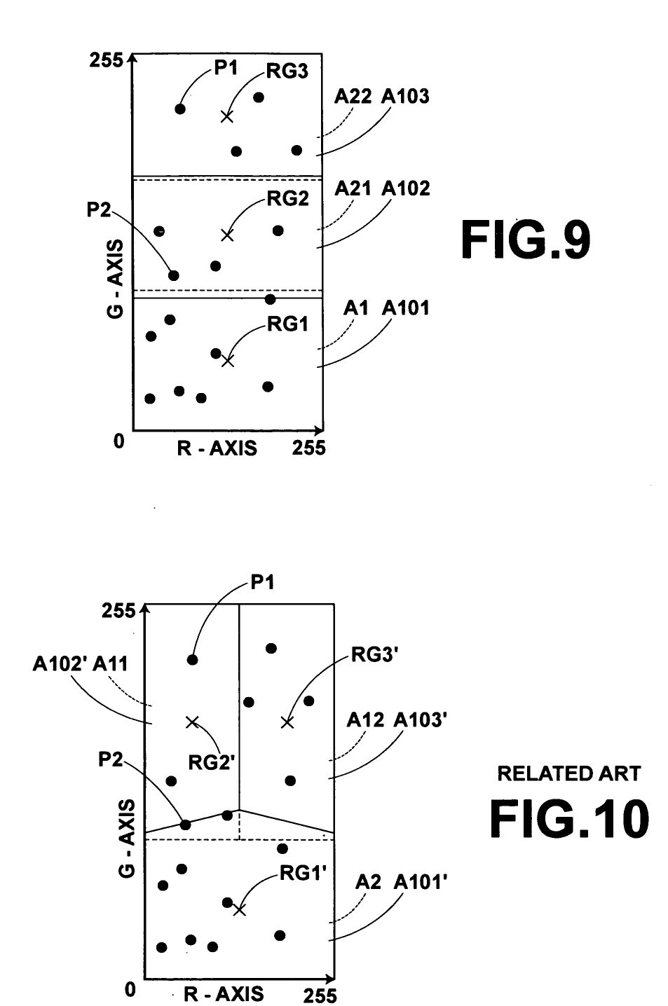

FIG. 9 is a diagram for explaining assignment of colors in the present embodiment. Here, for the purpose of explanation, it is assumed that an image includes two colors of R and G, and representative colors are selected in the state, in which the RG color space is divided into three regions, as illustrated in FIG. 6C. As illustrated in FIG. 9, the representative colors RG1, RG2, and RG3 are colors, which are medians in the regions A1, A21, and A22, respectively. Note that the boundaries among the regions A1, A21, and A22 are indicated with broken lines in FIG. 9. In the present embodiment, the distances between the color of each pixel in the raw image S1′ and all of the representative colors are calculated. A representative color, from which the distance to the color of each pixel is the shortest, is assigned to the corresponding pixel in the reduced color image. Therefore, perpendicular bisectors (solid lines in FIG. 9) of the representative colors RG1, RG2, and RG3 are set. Then, the representative colors RG1, RG2, and RG3, which are included in the regions A101, A102, and A103, respectively, are assigned to the colors of pixels in the regions A101, A102, and A103, respectively, which are divided by the perpendicular bisector lines.

FIG. 10 is a diagram, based on the human visual sense characteristics, for explaining assignment of colors according to the related art. Here, for the purpose of explanation, it is assumed that the RG color space is divided into three regions of A2, A11, and A12, as illustrated in FIG. 22C, and the representative colors are selected after the three regions are formed. Here, the color space illustrated in FIG. 10 is correlated with the color space illustrated in FIG. 6C. As illustrated in FIG. 10, representative colors RG1′, RG2′, and RG3′ are colors, which are medians in the regions A2, A11, and A12, respectively. In FIG. 10, boundaries among the regions A2, A11, and A12 are represented by broken lines. In the present embodiment, the distances between the color of each pixel in the raw image S1′ and all of the representative colors are calculated, and a representative color, from which the distance to the color of each pixel is the shortest, is assigned to the corresponding pixel in the reduced color image. Therefore, perpendicular bisectors (solid lines in FIG. 10) of the representative colors RG1′, RG2′, and RG3′ are set. The representative colors RG1′, RG2′, and RG3′, included in the regions A101′, A102′, and A103′, are assigned to the colors of pixels in the regions A101′, A102′, and A103′, respectively, which are divided by the perpendicular bisectors.

In FIG. 9, the pixels P1 and P2 belong to the regions A103 and A102, respectively. Therefore, the representative colors RG3 and RG2 are assigned to the pixels P1 and P2, respectively. Meanwhile, in FIG. 10, since the pixels P1 and P2 belong to the same region A102′, the representative color RG2′ is assigned to both of the pixels P1 and P2.

As described above, in the color assignment method according to the related art, the same representative color is assigned to colors, which are visually different from each other. However, according to the present embodiment, different representative colors are assigned to colors, which are visually different from each other.

The encoding unit 55 encodes the reduced color raw image data R0, and generates reduced color image data R1. A format such as gif (graphics interchange format) or png (portable network graphics) may be used as the file format of the reduced color image data R1, but the format is not limited to the above-mentioned formats.

The reduced color image output unit 56 outputs the reduced color image data R1, generated by the encoding unit 55, to the image output unit 16.

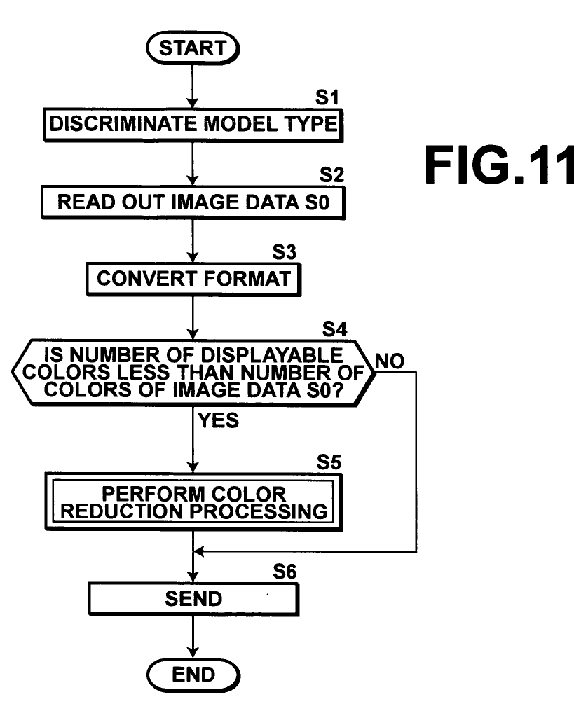

Next, processing performed in the first embodiment will be described. FIG. 11 is a flow chart illustrating processing performed in the first embodiment. When the request receipt unit 12 receives an image delivery request, which was sent by the mobile terminal device 3, processing starts. The model type discrimination unit 13 discriminates the model type of the mobile terminal device 3 based on model type information, included in the request (step S1). Then, the image format conversion unit 14 reads out image data S0, having a file name included in the request, from the image storage unit 11 (step S2). The image format conversion unit 14 converts the format of the image data S0 with reference to the table L1 so that the format becomes appropriate for the model type of the mobile terminal device 3, which has requested transmission, and obtains image data S1 after format conversion (step S3).

Next, the color reduction processing unit 15 judges whether the number of displayable colors at the mobile terminal device 3, which has requested transmission, is less than the number of colors of the image data S0 (step S4). If step S4 is YES, the color reduction processing unit 15 performs color reduction processing on the image data S1 (step S5).

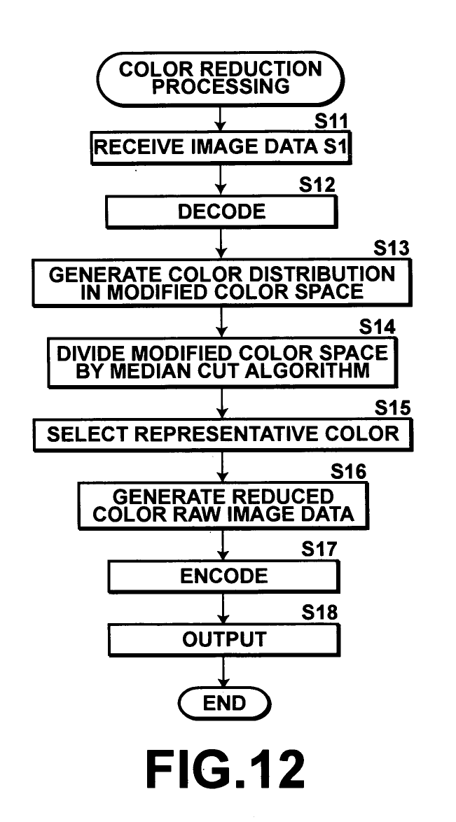

FIG. 12 is a flow chart illustrating color reduction processing. First, the image input unit 51 receives an input of the image data S1 (step S1). The decoding unit 52 decodes the image data S1, and obtains raw image data S1′ (step S12). Then, the color distribution generation unit 61 in the representative color selection unit 53 modifies the color space so that the length of an axis of each color of RGB satisfies the ratio of 3:4:2, and generates color distributions of the raw image data S1′ in the modified color space (step S13). Then, the region division unit 62 divides the modified color space by using the median cut algorithm until the number of divided regions reaches a predetermined number (step S14), and the selection unit 63 selects representative colors (step S15).

Then, the processing unit 54 modifies the color space so that the length of an axis of each color of RGB satisfies the ratio of √2:√3:1. The processing unit 54 generates reduced color raw image data R0 by assigning a representative color to the color of each pixel in the modified color space (step S16). The encoding unit 55 encodes the reduced color raw image data R0, and generates reduced color image data R1 (step S17). Further, the reduced color image output unit 56 outputs the reduced color image data R1 (step S18), and color reduction processing ends.

In FIG. 11, if step S4 is NO, or if color reduction processing in step S5 ends, the image output unit 16 sends the reduced color image data R1 or the image data S1 to the mobile terminal device 3, which has requested transmission (step S6), and processing ends.

The mobile terminal device 3 receives the reduced color image data R1 or the image data S1. Here, if the number of displayable colors at the mobile terminal device 3 is more than or equal to the number of colors of the image data S0, the image data S1 is sent. However, if the number of displayable colors at the mobile terminal device 3 is less than the number of colors of the image data S0, the reduced color image data R1 is sent, and the reduced color image data R1 is displayed.

As described above, in the present embodiment, the color space is modified so that an axis of each color of RGB satisfies the ratio of 3:4:2, which is appropriate for the human visual characteristics. Then, color distribution is generated in the modified color space, and a representative color is selected by using the median cut algorithm. Here, when the color space is RGB color space, if the length of an axis of each base color satisfies G>R>B, the direction of an axis, which will be divided by using the median cut algorithm, tends to be selected in the order of G, R, and B. Accordingly, the number of divided regions is larger in the order of G, R, and B. Therefore, color components of each representative color is divided into smaller regions in the order of G, R, and B. Here, in the human visual sense characteristics, sensitivity for G is the highest, and sensitivity is lower in the order of G, R and B. Therefore, if the number of times of division regarding a color is increased as the sensitivity for the color is higher, when a reduced color image is produced, an image, which looks more natural, can be produced. Hence, according to the present embodiment, a representative color can be selected so that a reduced color image, which is appropriate for the human visual sense characteristics, is produced.

When a representative color is assigned to the color of each pixel, the color space is changed so that the length of an axis of each color of RGB satisfies the ratio of √2:√3:1, which is appropriate for the human visual sense characteristics. Then, the color is assigned in the modified color space. Here, in the human visual sense characteristics, sensitivity for G is the highest, and the sensitivity is lower in the order of G, R and B. Therefore, when a difference in value is small, a difference in color of G can be recognized better than a difference in color of B. In the present embodiment, the length of an axis of each color of RGB is longer in the order of G, R, and B in the modified color space. Therefore, the characteristics of the color space are appropriate for the human visual sense characteristics. Accordingly, a reduced color image, which looks natural, may be produced in the modified color space by calculating the distances between the color of each pixel and all of the representative colors and assigning a representative color, from which the distance from the color of each pixel is the shortest, to a corresponding pixel in the reduced color image.

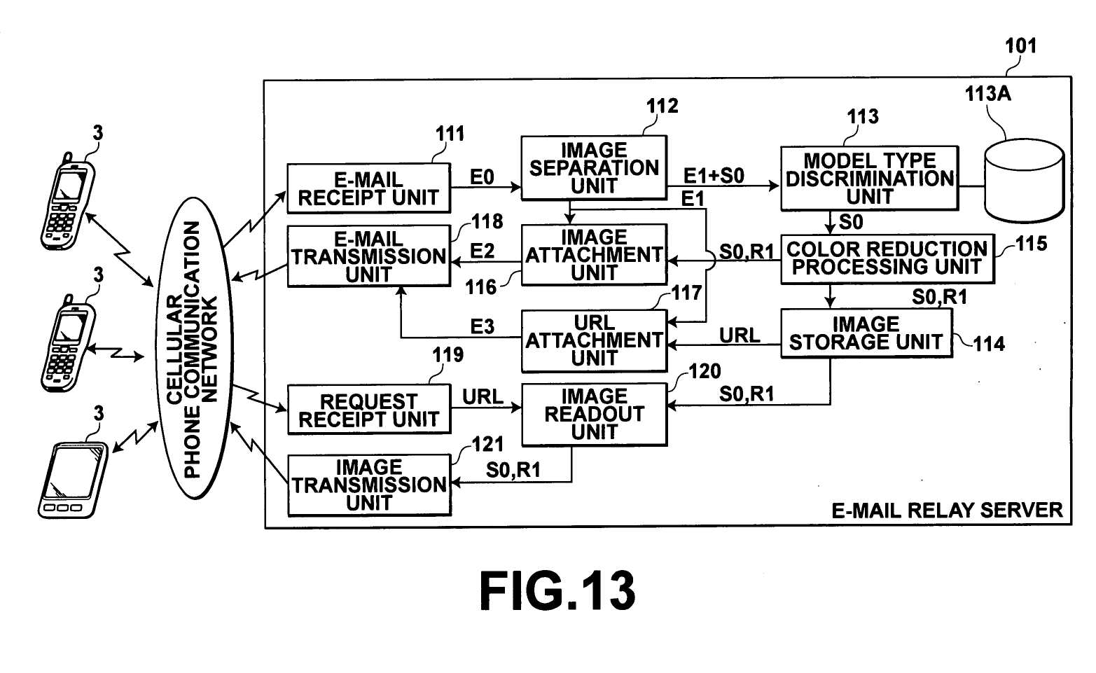

Next, a second embodiment of the present invention will be described. FIG. 13 is a schematic block diagram illustrating the configuration of an e-mail system, to which a reduced color image production apparatus and e-mail relay apparatus according to the second embodiment of the present invention are applied. As illustrated in FIG. 13, the e-mail system according to the second embodiment includes an e-mail relay server 101. In the e-mail system according to the present embodiment, an e-mail, to which an image is attached, is sent from the mobile terminal device 3 such as a cellular phone with a camera, a PHS with a camera and a PDA with a camera, which can take photographs. Then, the e-mail is relayed by the e-mail relay server 101 and sent to a transmission destination of the e-mail.

As illustrated in FIG. 13, the e-mail relay server 101 includes an e-mail receipt unit 111, an image separation unit 112, a model type discrimination unit 113, an image storage unit 114, a color reduction processing unit 115, an image attachment unit 116, a URL (Uniform Resource Locator) attachment unit 117, an e-mail transmission unit 118, a request receipt unit 119, an image readout unit 120, and an image transmission unit 121.

The e-mail receipt unit 111 receives an e-mail E0, to which image data S0 representing an image is attached, from a mobile terminal device 3.

The image separation unit 112 separates the image data S0 from the e-mail E0, and generates a mail body E1, which includes information of the e-mail E0 other than the image data S0. The mail body E1 includes a mail text and a header including various kinds of information such as the e-mail address of a sender and the e-mail address of a destination. The image separation unit 112 inputs the mail body E1 and the image data S0 to the model type discrimination unit 113.

The model type discrimination unit 113 refers to a database 113A, which shows the correspondence between e-mail addresses and model types, and judges whether the number of displayable colors of the mobile terminal device 3 at the destination is less than the number of colors of the image data S0. The judgment is made based on the e-mail address of the mobile terminal device 3 at the destination, which is included in the header of the mail body E1. The model type discrimination unit 113 also judges whether the mobile terminal device 3 at the destination can receive the e-mail, to which the image is attached, without reducing data.

Here, judgment results by the model type discrimination unit 113 will be described below:
(1) The number of displayable colors of the mobile terminal device 3 at the destination is more than or equal to the number of colors of the image data S0, and the mobile terminal device 3 can receive an e-mail, to which an image is attached, without reducing data;
(2) The number of displayable colors of the mobile terminal device 3 at the destination is less than the number of colors of the image data S0, and the mobile terminal device 3 can receive an e-mail, to which an image is attached, without reducing data;
(3) The number of displayable colors of the mobile terminal device 3 at the destination is more than or equal to the number of colors of the image data S0, and the mobile terminal device 3 cannot receive an e-mail, to which an image is attached, without reducing data; and
(4) The number of displayable colors of the mobile terminal device 3 at the destination is less than the number of colors of the image data S0, and the mobile terminal device 3 cannot receive an e-mail, to which an image is attached, without reducing data.

If the judgment result is as described in the above item (1), the model type discrimination unit 113 inputs the image data S0 to the image attachment unit 116 without causing the color reduction processing unit 115 to perform color reduction processing. Further, the image separation unit 112 inputs the mail body E1 to the image attachment unit 116.

If the judgment result is as described in the above item (2), the model type discrimination unit 113 inputs the image data S0 to the color reduction processing unit 115, and causes the color reduction processing unit 115 to perform color reduction processing. Further, the image separation unit 112 inputs the mail body E1 to the image attachment unit 116.

If the judgment result is as described in the above item (3), the model type discrimination unit 113 inputs the image data S0 to the image storage unit 114 without causing the color reduction processing unit 115 to perform color reduction processing. Further, the image separation unit 112 inputs the mail body E1 to the URL attachment unit 117.

If the judgment result is as described in the above item (4), the model type discrimination unit 113 inputs the image data S0 to the color reduction processing unit 115, and causes the color reduction processing unit 115 to perform color reduction processing. Further, the image separation unit 112 inputs the mail body E1 to the URL attaching unit 117.

The image storage unit 114 stores the image data S0 and the reduced color image data R1, which was generated by the color reduction processing unit 115.

If the number of displayable colors of the mobile terminal device 3 at the destination is less than the number of colors of the image data S0, the color reduction processing unit 115 generates reduced color image data R1 from the image data S0. The configuration of the color reduction processing unit 115 is the same as that of the color reduction processing unit 15 in the image delivery server 1 in the first embodiment as described above. Further, the processing in the color reduction processing unit 115 is the same as the processing in the color reduction processing unit 15. Therefore, detailed explanation on the color reduction unit 115 will be omitted.

If the mobile terminal device 3 at the destination can receive the e-mail, to which an image is attached, without reducing data, the image attachment unit 116 attaches the image data S0 or the reduced color image data R1 to the mail body E1, and generates an e-mail E2, to which an image is attached. The image attachment unit 116 also converts format of the image data S0.

If the mobile terminal device 3 at the destination cannot receive the e-mail, to which the image is attached, without reducing data, the URL attachment unit 117 attaches a URL of a storage location of the image data S0 or the reduced color image data R1 in the image storage unit 114 to the mail body E1, and generates an e-mail E3, to which the URL is attached.

The e-mail transmission unit 118 sends the e-mail E2 or the e-mail E3 to the mobile terminal device 3 at the destination via a cellular phone communication network.

The request receipt unit 119 receives an image download request from the mobile terminal device 3, which has received the e-mail E3, to which the URL is attached. The image delivery request from the mobile terminal device 3 includes the URL of the storage location of the image data S0 or the reduced color image data R1.

The image readout unit 120 refers to the URL included in the request, which has been received by the request receipt unit 119, and reads out the image data S0 or the reduced color image data R1 from the image storage unit 114.

The image transmission unit 121 sends the image data S0 or the reduced color image data R1, which has been read out by the image readout unit 120, to the mobile terminal device 3, which sent the request, via the cellular phone communication network.

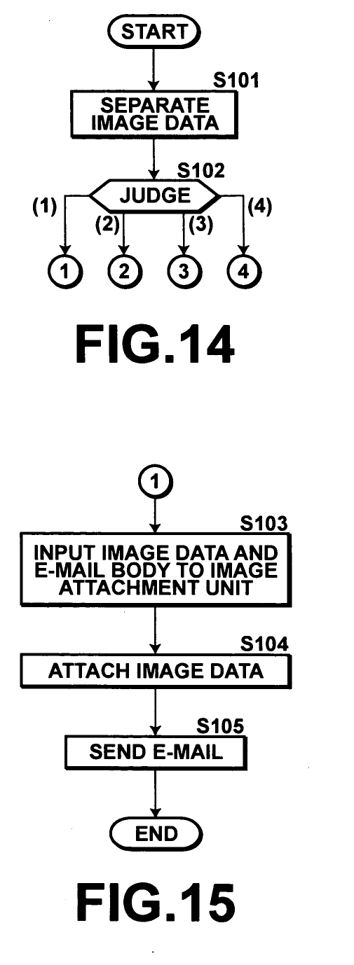

Next, processing in the second embodiment will be described. FIG. 14 is a flow chart illustrating the processing performed in the second embodiment. When the e-mail receipt unit 111 receives an e-mail E0, to which image data S0 is attached, from a mobile terminal device 3, processing starts. Then, the image separation unit 112 separates the image data S0 from the e-mail E0 (step S101). Next, the model type discrimination unit 113 refers to the database 113A, and judges which the mobile terminal device 3 at the destination satisfies in the above items (1)-(4). The judgment is made based on the e-mail address of the mobile terminal device 3, which is included in the header of the mail body E1 (step S102).

If the mobile terminal device 3 satisfies the item (1), processing goes to the steps illustrated in the flow chart of FIG. 15. Then, the model type discrimination unit 113 inputs the image data S0 to the image attaching unit 116, and the image separation unit 112 inputs the mail body E1 to the image attachment unit 116 (step S103). The image attachment unit 116 attaches the image data S0 to the mail body E1, and generates an e-mail E2, to which the image is attached (step S104). The e-mail transmission unit 118 sends the e-mail E2 to the mobile terminal device 3 at the destination (step S105), and processing ends.

The mobile terminal device 3, which has received the e-mail E2, displays the image, represented by the image data S0, which is attached to the e-mail E2.

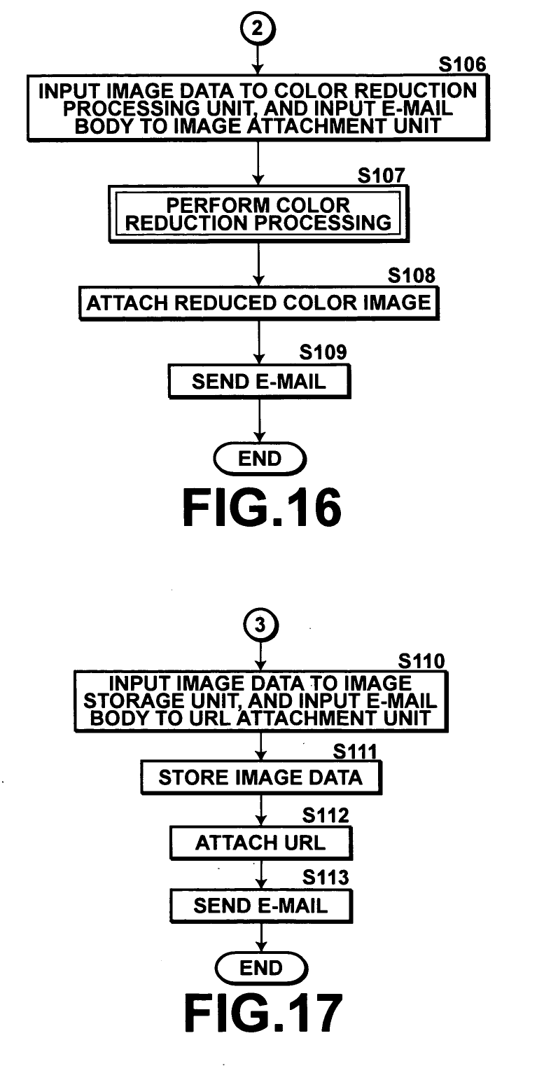

Meanwhile, if the mobile terminal device 3 satisfies the item (2), processing goes to the steps illustrated in the flow chart of FIG. 16. Then, the model type discrimination unit 113 inputs the image data S0 to the color reduction processing unit 115, and the image separation unit 112 inputs the mail body E1 to the image attachment unit 116 (step S106). The color reduction processing unit 115 performs color reduction processing on the image data S0 (step S107). The color reduction processing is performed in a similar manner to the color reduction processing in the first embodiment. Specifically, the color space is modified so that the ratio of an axis of each color of RGB satisfies the ratio of 3:4:2, and color distribution is generated in the modified color space to select a representative color. Further, the color space is modified so that the ratio of an axis of each color of RGB satisfies the ratio of √2:√3:1. Then, reduced color image data R1 is generated by assigning colors in the modified color space.

After step S107, the image attachment unit 116 attaches the reduced color image data R1 to the mail body E1, and generates the e-mail E2, to which the image is attached (step S108). Then, the e-mail transmission unit 118 sends the e-mail E2 to the mobile terminal device 3 at the destination (step S109), and processing ends.

The mobile terminal device 3, which has received the e-mail E2, displays the reduced color image R1.

If the mobile terminal device 3 satisfies the item (3), processing goes to the steps illustrated in the flow chart of FIG. 17. Then, the model type discrimination unit 113 inputs the image data S0 to the image storage unit 114, and the image separation unit 112 inputs the mail body E1 to the URL attachment unit 117 (step S110). The image storage unit 114 stores the image data S0 (step S111). The URL attaching unit 117 attaches the URL of the storage location of the image data S0 to the mail body E1, and generates the e-mail E3, to which the URL is attached (step S112). Then, the e-mail transmission unit 118 sends the e-mail E3 to the mobile terminal device 3 at the destination (step S113), and processing ends.

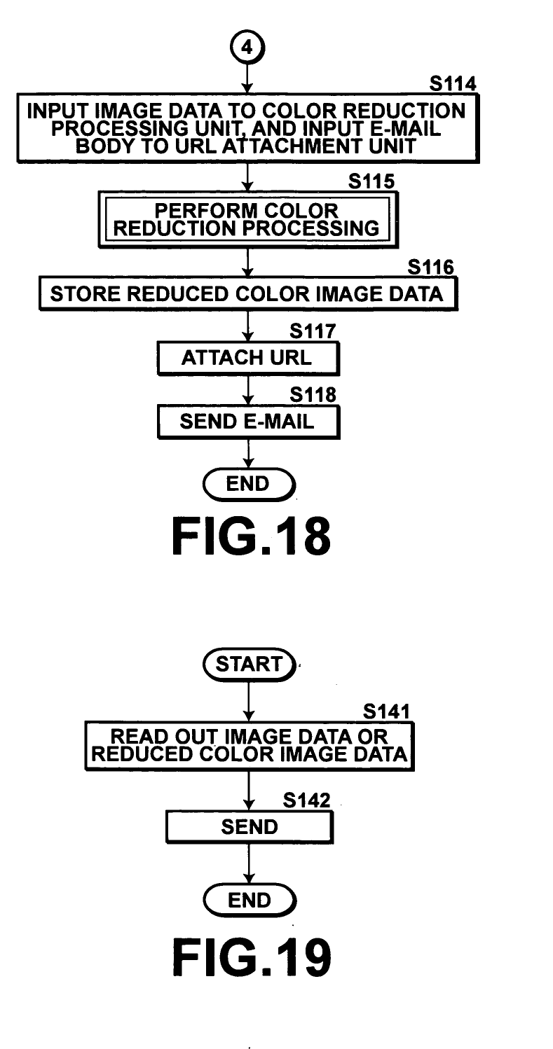

If the mobile terminal device 3 satisfies the item (4), processing goes to the steps illustrated in the flow chart of FIG. 18. Then, the model type discrimination unit 113 inputs the image data S0 to the color reduction processing unit 115, and the image separation unit 112 inputs the mail body E1 to the URL attachment unit 117 (step S114). The color reduction processing unit 115 performs color reduction processing on the image data S0 (step S115). The image storage unit 114 stores the reduced color image data R1 (step S116). The URL attaching unit 117 attaches the URL of the storage location to the mail body E1, and generates the e-mail E3, to which the URL is attached (step S117). Then, the e-mail transmission unit 118 sends the e-mail E3 to the mobile terminal device 3 at the destination (step S118), and processing ends.

If the mobile terminal device 3 satisfies the item (3) or (4) as described above, the mobile terminal device 3, which has received the e-mail E3, sends a download request of the image data S0 or the reduced color image data R1 to the e-mail relay server 101.

FIG. 19 is a flow chart illustrating the processing performed by the e-mail relay se0rver 101 when the request is sent to the e-mail relay server 101. When the request receipt unit 119 receives a download request, the e-mail relay server 101 starts processing. The image readout unit 120 refers to a URL included in the request, and reads out the image data S0 or the reduced color image data R1 from the image storage unit 114 (step S141). Then, the image transmission unit 121 sends the image data S0 or the reduced color data R1 to the mobile terminal device 3, which has sent the request (step S142), and processing ends.

The mobile terminal device 3 receives the reduced color image data R1 or the image data S0. Here, if the number of displayable colors at the mobile terminal device 3 is more than or equal to the number of colors of the image data S0, the image data S0 is sent, and an image, represented by the image data S0, is displayed. However, if the number of displayable colors of the mobile terminal device 3 is less than the number of colors of the image data S0, the reduced color image data R1 is sent, and a reduced color image, represented by the reduced color image data R1, is displayed.

In the second embodiment as described above, the image separation unit 112 temporarily stores the e-mail E0, to which the image data M0 is attached. If the model type discrimination unit 113 judges that the mobile terminal device 3 satisfies the item (1) as described above, the transmission unit 118 may send the e-mail E0, to which the image data S0 is attached, to the mobile terminal device 3 at the destination without reducing data.

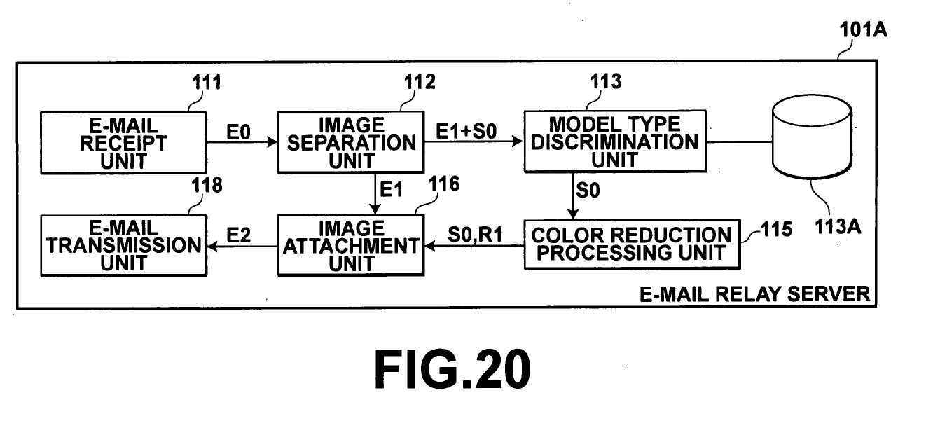

In the second embodiment as described above, the e-mail relay server 101 relays the e-mail regardless of whether the mobile terminal device 3 at the destination can receive the e-mail, to which the image is attached, without reducing data. However, the e-mail relay server 101 may also be configured as a specialized relay server 101, which is used when the mobile terminal device 3 at the destination can receive the e-mail, to which the image is attached, without reducing data. An e-mail relay server (referred to as an e-mail relay server 101A) which is configured in this manner is illustrated in FIG. 20, as a third embodiment of the invention. When the e-mail relay server 101A in FIG. 20 and the e-mail relay server 101 in FIG. 13 are compared with each other, the image storage unit 114, the URL attachment unit 117, the request receipt unit 119, the image readout unit 120, and the image transmission unit 121 in the e-mail relay server 101 are not included in the e-mail relay server 101A.

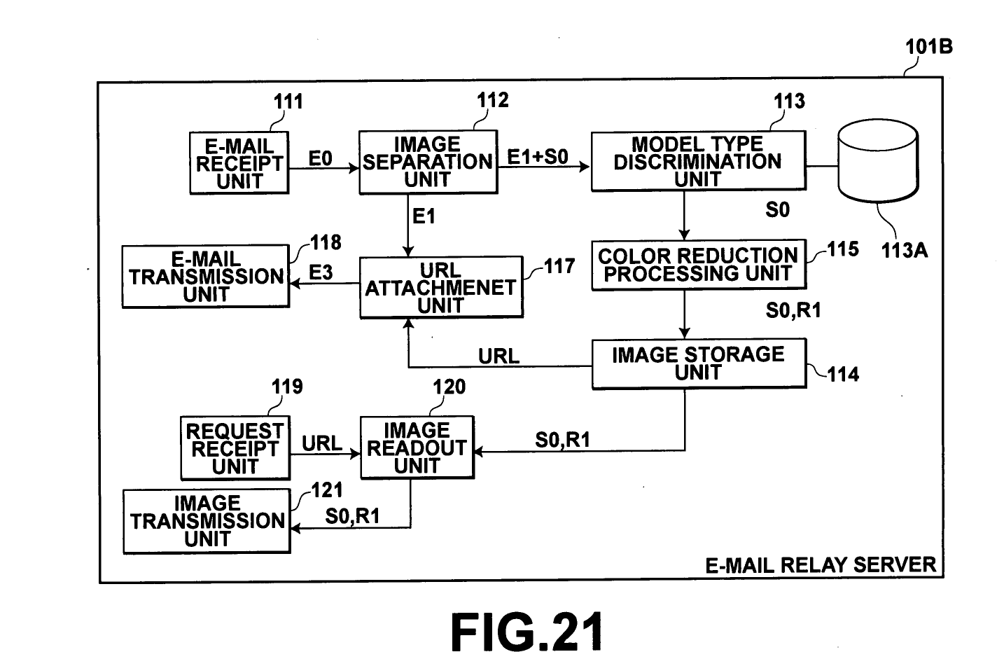

Alternatively, the e-mail relay server 101 may also be configured as a specialized e-mail relay server, which is used when the mobile terminal device 3 at the destination cannot receive the e-mail, to which the image is attached, without reducing data. An e-mail relay server (called 101B), which is configured in this manner, is illustrated in FIG. 21, as a fourth embodiment. When the e-mail relay server 101B in FIG. 21 and the e-mail relay server 101 in FIG. 13 are compared with each other, the image attachment unit 116 in the e-mail relay server 101 is not in the e-mail relay server 101B.

In the first through fourth embodiments, as described above, the file size of image data, which can be displayed at the mobile terminal device 3, is limited. Therefore, if the reduced color image data R1 is sent to the mobile terminal device 3 without considering the limitation in the file size, even if the reduced color image data R1 is sent, the mobile terminal device 3 cannot display the reduced color image in some cases.

Therefore, the reduced color image data R1 is generated so that the file size of the reduced color image data R1 is appropriate for the model type of the mobile terminal device 3, which has sent the request, or the model type of the mobile terminal device 3 at the destination. Accordingly, the problems that although the reduced color image data R1 is sent, the mobile terminal device 3 cannot display the reduced color image can be prevented.

Further, the color reduction processing unit 15 in the first embodiment and the color reduction processing unit 115 in the second to fourth embodiments may be used independently as a reduced color image production apparatus for producing a reduced color image from an image. In this case, the image data S0 may be converted into the reduced color image data R1 regardless of the model type of the mobile terminal device 3.

Further, in the embodiments 1 through 4, as described above, when the representative color is selected, the color space is modified so that the length of an axis of each color of RGB satisfies the ratio of 3:4:2. However, the length of an axis of each color of RGB may be set to any ratio as far as the ratio is appropriate for the human visual sense characteristics.

Further, in the embodiments 1 through 4, as described above, when a color is assigned, the color space is modified so that the length of an axis of each color of RGB satisfies the ratio of √2:√3:1. However, the length of an axis of each color of RGB may be set to any ratio as far as the ratio is appropriate for the human visual sense characteristics.

Further, in the embodiments 1 through 4, as described above, a color, which is a median in each region, is used as the representative color. However, a color, which is an average, a centroid value, or the like, may be used as the representative color.

1. A representative color selection apparatus for selecting a predetermined number of representative colors from colors of pixels in an image to produce a reduced color image, represented by the predetermined number of colors, which is less than the number of reproducible colors of the image, the apparatus comprising:
a color distribution generation means for generating color distributions of the color of each of the pixels in modified color space, in which the length of an axis of each base color in a color space of the image is modified to a length, which is appropriate for human visual sense characteristics, and which are different from each other;
a region division means for dividing the modified color space, based on the color distribution, into a predetermined number of regions, which is the same as the number of the predetermined number of colors, by using median cut algorithm; and
a selection means for selecting a representative color of each of the divided regions.

2. A representative color selection apparatus as defined in claim 1, wherein when the color space is RGB color space, the color distribution generation means is a means for modifying the length of an axis of each base color so as to satisfy G>R>B.

3. A representative color selection apparatus as defined in claim 2, wherein the length of an axis of each base color satisfies the ratio of R:G:B=3:4:2.

4. A representative color selection apparatus as defined in claim 1, wherein the representative color is a color represented by one of a median, average, and centroid value in each of the regions.

5. A reduced color image production apparatus for producing a reduced color image including a predetermined number of representative colors, selected from the colors of pixels in an image, by assigning one of the predetermined number of representative colors to each of the pixels of the image, the apparatus comprising:
an image production means for producing the reduced color image in modified color space, in which the length of an axis of each base color in a color space of the image is modified to a length, which is appropriate for human visual sense characteristics, and which are different from each other, by calculating distances between the color of each of the pixels and all of the representative colors and assigning a representative color, from which the distance is the shortest to the color of each of the pixels, to a corresponding pixel in the reduced color image.

6. A reduced color image production apparatus as defined in claim 5, wherein when the color space is RGB color space, the color distribution generation means is a means for modifying the length of an axis of each base color so as to satisfy G>R>B.

7. A reduced color image production apparatus as defined in claim 6, wherein the length of an axis of each base color satisfies the ratio of R:G:B=√2:√3:1.

8. A reduced color image production apparatus as defined in claim 5, further comprising:
a color distribution generation means for generating color distributions of the color of each of the pixels in modified color space, in which the length of an axis of each base color in a color space of the image is modified to a length, which is appropriate for human visual sense characteristics, and which are different from each other;
a region division means for dividing the modified color space, based on the color distribution, into a predetermined number of regions, which is the same as the number of the predetermined number of colors, by using median cut algorithm; and
a selection means for selecting a representative color of each of the divided regions.

9. A reduced color image production apparatus as defined in claim 8, wherein the degree of modifying the length of an axis of each base color in the color space of the image is different between selection time of the representative color and assignment time of the representative color to each of the pixels.

10. A reduced color image production apparatus as defined in claim 5, wherein the representative color is a color represented by one of a median, average, and centroid value in each of the regions.

11. An image delivery apparatus for sending a requested image to a transmission request terminal device, which has requested transmission of the image, the apparatus comprising:
a model type discrimination means for discriminating the model type of the transmission request terminal device; and
the reduced color image production apparatus as defined in claim 3, wherein when the number of displayable colors of the model type of the transmission request terminal device is less than the number of colors of the image, a reduced color image is produced from the requested image, and the reduced color image is sent to the transmission request terminal device instead of the image.

12. An e-mail relay apparatus for sending an e-mail, to which an image is attached, to a transmission destination terminal device, which is a transmission destination of the e-mail, the apparatus comprising:
a model type discrimination means for discriminating the model type of the transmission destination terminal device; and
the reduced color image production apparatus as defined in claim 3, wherein when the number of displayable colors of the model type of the transmission destination terminal device is less than the number of colors of the image, a reduced color image is produced from the attached image, and the reduced color image is sent to the transmission destination terminal device instead of the image.

13. A representative color selection method for selecting a predetermined number of representative colors from colors of pixels in an image to produce a reduced color image, represented by the predetermined number of colors, which is less than the number of reproducible colors of the image, the method comprising the steps of:
generating color distribution of the color of each of the pixels in modified color space, in which the length of an axis of each base color in a color space of the image is modified to a length, which is appropriate for human visual sense characteristics, and which are different from each other;
dividing the modified color space, based on the color distribution, into a predetermined number of regions, which is the same as the number of the predetermined number of colors, by using median cut algorithm; and
selecting a representative color of each of the divided regions.

14. A reduced color image production method for producing a reduced color image including a predetermined number of representative colors, selected from the colors of pixels in an image, by assigning one of the predetermined number of representative colors to each of the pixels, the method comprising the step of:
producing the reduced color image in modified color space, in which the length of an axis of each base color in a color space of the image is modified to a length, which is appropriate for human visual sense characteristics, and which are different from each other, by calculating distances between the color of each of the pixels and all of the representative colors and assigning a representative color, from which the distance to the color of each of the pixels is the shortest, to a corresponding pixel in the reduced color image.

15. A program for causing a computer to execute a representative color selection method for selecting a predetermined number of representative colors from colors of pixels in an image to produce a reduced color image, represented by the predetermined number of colors, which is less than the number of reproducible colors of the image, the program comprising the procedures for:
generating color distribution of the color of each of the pixels in modified color space, in which the length of an axis of each base color in a color space of the image is modified to a length, which is appropriate for human visual sense characteristics, and which are different from each other;
dividing the modified color space, based on the color distribution, into a predetermined number of regions, which is the same as the number of the predetermined number of colors, by using median cut algorithm; and
selecting a representative color of each of the divided regions.

16. A program for causing a computer to execute a reduced color image production method for producing a reduced color image including a predetermined number of representative colors, selected from the colors of pixels in an image, by assigning one of the predetermined number of representative colors to each of the pixels, the program comprising the procedure for:
producing the reduced color image in modified color space, in which the length of an axis of each base color in a color space of the image is modified to a length, which is appropriate for human visual sense characteristics, and which are different from each other, by calculating distances between the color of each of the pixels and all of the representative colors and assigning a representative color, from which the distance to the color of each of the pixels is the shortest, to a corresponding pixel in the reduced color image.

17. A computer readable medium, having the program as defined in claim 15 recorded therein.

18. A computer readable medium, having the program as defined in claim 16 recorded therein.
